(19) United States
(12) Patent Application Publication
(10) Pub. No.: US 2020/0195803 A1
(43) Pub. Date: Jun. 18, 2020

(54) IMAGE PROCESSING SYSTEM, IMAGE PROCESSING APPARATUS, CLOUD SERVER, AND PROGRAM

(71) Applicant: KONICA MINOLTA, INC., Tokyo (JP)

(72) Inventor: Minako KOBAYASHI, Osaka (JP)

(73) Assignee: KONICA MINOLTA, INC., Tokyo (JP)

(21) Appl. No.: 16/680,993

(22) Filed: Nov. 12, 2019

(30) Foreign Application Priority Data
Dec. 14, 2018 (JP) 2018-234235

(51) Int. Cl. H04N 1/00; G10L 15/22

(52) U.S. Cl. CPC H04N 1/00896; H04N 1/00403; G10L 2015/223; H04N 1/00395; H04N 1/00854; G10L 15/22

(57) ABSTRACT

An image processing system includes an image processing apparatus and a cloud server, the image processing system being capable of operating the image processing apparatus through a cooperation process among the image processing apparatus, the cloud server, and an external device, wherein the cloud server includes: an acquirer that acquires from the external device a voice instruction for operating the image processing apparatus, the voice instruction being given by the user in a conversation between the user and the external device; and an instruction transmitter that transmits an instruction command based on the voice instruction to the image processing apparatus, the image processing apparatus includes: an operation inputter; a setter; and a reset controller, and, when the image processing apparatus starts to be operated by the voice instruction, the reset controller of the image processing apparatus prevents execution of the auto reset.

The entire disclosure of Japanese patent Application No. 2018-234235, filed on Dec. 14, 2018, is incorporated herein by reference in its entirety.

### BACKGROUND

### Technological Field

The present invention relates to an image processing system including an image processing apparatus such as a multi-function peripheral (MFP), and related technologies.

### Description of the Related Art

Some MFPs have a function (also called an auto reset function) of automatically resetting settings contents that have been set through an operation panel unit, in a case where any operation has not been performed on the operation panel unit over a certain period of time (see JP 2004-109352 A). Such an auto reset function is particularly useful in a case where an MFP is shared by a plurality of users, for example.

Further, there is a technology for operating a target apparatus by issuing a user instruction (a voice instruction) using an audio device such as a smart speaker (an AI speaker). More specifically, voice data that has been input to an audio device is transmitted to a cloud server, and a natural language analyzing process for the voice data is performed by the cloud server, to identify the contents of the user instruction. Such a technology (a natural language analyzing process or the like by a cloud server) is applied so that an MFP can be operated by voice. For example, various kinds of settings in a copy job to be executed by an MFP can be designated by voice (such as “Make a copy.” and “Two-sided printing”).

In a case where an MFP setting process is performed with an audio device, the above described auto reset function is preferably modified as follows. Specifically, in a case where any user instruction from an audio device via a cloud server is not transmitted to the MFP over a certain period of time (50 seconds, for example), it is determined that a predetermined non-instruction period has elapsed, and the settings contents in the MFP are reset.

However, in a case where such a modification is made, the process only between the audio device and the cloud server might take a relatively long time. In other words, any instruction to the MFP might not be issued over a relatively long period of time (70 seconds, for example). For example, to check the contents of an unclear instruction issued from the user, voice data for a voice output might be transmitted from the cloud server to the audio device, and an instruction from the user might be input again through a voice output based on the voice data. In this case, there is a high possibility that a relatively long non-instruction period will elapse.

In such a case, it is determined that any instruction from the cloud server to the MFP has not been issued over a certain period of time (or a predetermined non-instruction period has elapsed), though the cooperation process among the audio device, the cloud server, and the MFP is actually being continued. As a result, the MFP automatically resets the settings contents stored therein (an auto reset). In such a situation, it takes a lot of trouble for the user to perform the setting again from the beginning.

### SUMMARY

Therefore, an object of the present invention is to provide a technology for preventing the occurrence of any unnecessary auto reset in an image processing apparatus.

To achieve the abovementioned object, according to an aspect of the present invention, an image processing system reflecting one aspect of the present invention comprises an image processing apparatus, and a cloud server, the image processing system being capable of operating the image processing apparatus through a cooperation process among the image processing apparatus, the cloud server, and an external device, wherein the cloud server includes: an acquirer that acquires from the external device a voice instruction for operating the image processing apparatus, the voice instruction being given by the user in a conversation between the user and the external device; and an instruction transmitter that transmits an instruction command based on the voice instruction to the image processing apparatus, the image processing apparatus includes: an operation inputter that accepts an operation input instruction generated by the user's finger; a setter that sets settings information relating to an operation of the image processing apparatus, in accordance with at least one of a reception instruction including the instruction command transmitted from the cloud server and the operation input instruction generated by the user's finger; and a reset controller that performs an auto reset to reset the settings information set by the setter, in response to elapse of a predetermined non-instruction period, and, when the image processing apparatus starts to be operated by the voice instruction, the reset controller of the image processing apparatus prevents execution of the auto reset.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram showing the configuration of an image processing system according to a first embodiment;

FIG. 2 is a diagram showing the functional blocks of an MFP;

FIG. 3 is a diagram showing the functional blocks of a cloud server;

FIG. 4 is a conceptual diagram showing an outline of operation according to the first embodiment;

FIG. 5 is a flowchart showing operation of the cloud server;

FIG. 6 is a flowchart showing operation of the cloud server;

FIG. 7 is a flowchart showing operation of the MFP;

FIG. 8 is a timing chart showing an example operation in the image processing system;

FIG. 9 is a conceptual diagram showing an outline of operation according to a second embodiment;

FIG. 10 is a diagram showing the functional blocks of an MFP;

FIG. 11 is a flowchart showing operation of a cloud server;

FIG. 12 is a flowchart showing operation of the MFP;

FIG. 13 is a timing chart showing an example operation in the image processing system;

FIG. 14 is a conceptual diagram showing an outline of operation according to a third embodiment;

FIG. 15 is a flowchart showing operation of a cloud server;

FIG. 16 is a timing chart showing an example operation in the image processing system;

FIG. 17 is a flowchart showing an operation (such as a dummy command transmission operation) of the cloud server;

FIG. 18 is a conceptual diagram showing an outline of operation according to a fourth embodiment;

FIG. 19 is a flowchart showing operation of a cloud server;

FIG. 20 is a timing chart showing an example operation in the image processing system; and

FIG. 21 is a timing chart showing an example operation according to a comparative example.

### DETAILED DESCRIPTION OF EMBODIMENTS

Hereinafter, one or more embodiments of the present invention will be described with reference to the drawings. However, the scope of the invention is not limited to the disclosed embodiments.

### 1. First Embodiment

### 1-1. System Configuration

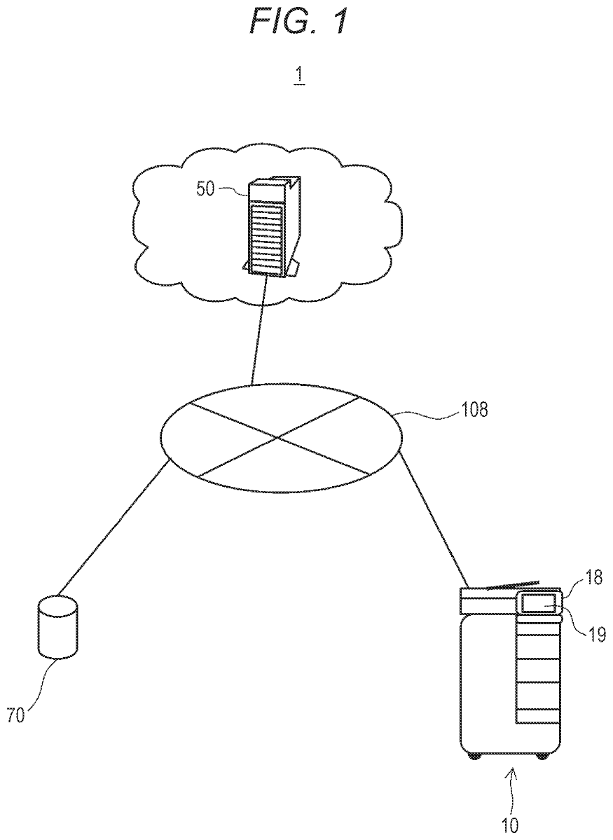

FIG. . 1 is a schematic diagram showing the configuration of an image processing system 1 according to a first embodiment of the present invention. As shown in FIG. 1, the image processing system 1 includes a cloud server 50, an MFP 10, and an audio device (an external device) 70.

The MFP 10 and the cloud server 50 are connected to each other via a network 108. The audio device 70 and the cloud server 50 are also connected to each other via the network 108. The network 108 is formed with a local area network (LAN), the Internet, or the like. Further, the mode of connection to the network 108 may be wired connection, or may be wireless connection.

The audio device 70 is a device that includes a speaker (a voice output unit) and a microphone (a voice input unit). This audio device 70 is a so-called smart speaker The audio device 70 can communicate with the cloud server 50 via the network 108, to exchange voice information and the like with the cloud server 50. The cloud server 50 can receive input voice (input voice data) from the audio device 70, and perform a natural language analyzing process on the voice (the input voice), to receive a user instruction through the input voice. The cloud server 50 can also transmit voice (a responding voice, or specifically, voice data) in response to the user instruction or the like to the audio device 70, to output the responding voice (a voice output) via the speaker of the audio device 70,

Next, the MFP 10 and the cloud server 50 are described.

### 1-2. Configuration of an MFP 10

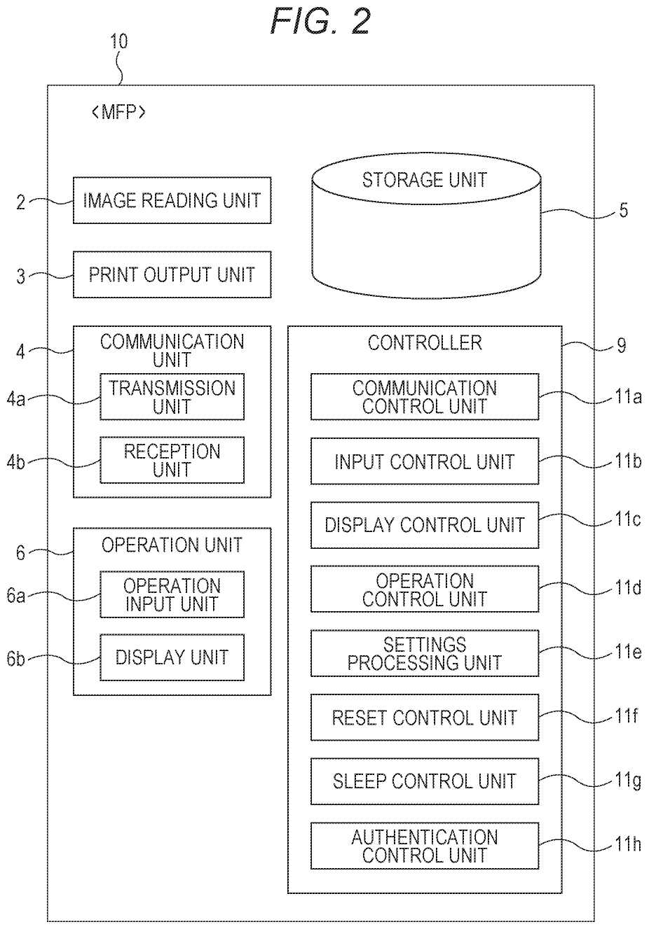

FIG. 2 is a diagram showing the functional blocks of the multi-functional peripheral (MFP) 10.

The MFP 10 is an apparatus (also referred to as a multi-function machine) having a scan function, a copy function, a facsimile function, a box storage function, and the like. Specifically, as shown in the functional block diagram in FIG. 2, the MFP 10 includes an image reading unit 2, a print output unit 3, a communication unit 4, a storage unit 5, an operation unit 6, and a controller 9, and achieves the various functions by causing the respective components to operate in combination. The MFP 10 is also referred to as an image processing apparatus, an image forming apparatus, or the like.

The image reading unit 2 is a processing unit that optically reads (or scans) a document placed at a predetermined position on the MFP 10, and generates image data (also referred to as a document image or a scanned image) of the document. The image reading unit 2 is also referred to as a scan unit.

The print output unit 3 is an output unit that prints and outputs images onto various kinds of media, such as paper, in accordance with data relating to the print target. The MFP 10 is also an electrophotographic printer (a full-color printer), and the print output unit 3 has various hardware mechanisms such as an exposure unit, a developing unit, a transfer unit, and a fixing unit.

The communication unit 4 is a processing unit capable of performing facsimile communication via a public line or the like. The communication unit 4 can further perform network communication via the network 108. In the network communication, various kinds of protocols such as TCP/IP (Transmission Control Protocol/Internet Protocol) and HTTP (HyperText Transfer Protocol) are used, for example. Using the network communication, the MFP 10 can exchange various kinds of data with a desired communication destination (such as the cloud server 50). The communication unit 4 includes a transmission unit 4a that transmits various kinds of data, and a reception unit 4b that receives various kinds of data.

The storage unit 5 is formed with a storage device such as a semiconductor memory (a RAM or the like) and a hard disk drive (HDD) or the like. The storage unit 5 (a semiconductor memory or the like) of the MFP 10 temporarily stores settings contents (including settings information and the like transmitted from the cloud server 50) relating to the job to be executed in the MFP 10.

The operation unit 6 includes an operation input unit 6a that receives an operation input directed to the MFP 10, and a display unit 6b that displays and outputs various kinds of information. The MFP 10 includes a plate-like operation panel unit 18 (see FIG. 1), and the operation panel unit 18 has a touch panel 19 (see FIG. 1) on its front side. The touch panel 19 has a piezoelectric sensor or the like buried in a liquid crystal display panel, and can display various kinds of information and receive an operation input from an operator. For example. the touch panel 19 displays various kinds of screens (including button images or the like), such as a menu screen. The operator can change the contents of various settings of the MFP 10 by pressing buttons (buttons represented by button images) virtually arranged in the touch panel 19. The touch panel 19 functions as part of the operation input unit 6a, and also functions as part of the display unit 6b.

The controller (a control unit) 9 is a control device that is built in the MFP 10, and comprehensively controls the MFP 10. The controller 9 is formed as a computer system that includes a CPU and various kinds of semiconductor memories (a RAM and a ROM). The controller 9 forms various kinds of processing units, as the CPU executes a predetermined software program (hereinafter also referred to simply as the program) stored in a ROM (such as an EEPROM (registered trademark)). Note that the program (more specifically, a program module group) may be recorded in a portable recording medium such as a USB memory, be read out from the recording medium, and he installed into the MFP 10. Alternatively, the program may be downloaded via a network or the like, and be installed into the MFP 10.

Here, “voice application software” Q1 (application software for operating the MFP 10 by voice, in cooperation with the audio device 70 or the cloud server 50) is installed as the program in the MFP 10. In other words, application software for cooperating with the cloud server 50 and the MFP 10 (or application software for performing a setting process in the MFP 10 on the basis of the settings information transmitted from the cloud server) is installed in the MFP 10. The “voice application software” (Q1) is also called a “voice application” or a “voice app”.

Specifically, the controller 9 executes the program, to form various kinds of processing units including a communication control unit 11a, an input control unit 11b, a display control unit 11c, an operation control unit 11d, a settings processing unit 11e, a reset control unit 11f, a sleep control unit 11g, and an authentication control unit 11h, as shown in FIG. 2.

The communication control unit 11a is a processing unit that controls communication operations with another apparatus (such as the cloud server 50).

The display control unit 11c is a processing unit that controls display operations in the display unit 6b. The display control unit 11c causes the display unit 6b to display an operation screen (including a settings screen relating to jobs in the MFP 10) for operating the MFP 10.

The input control unit 11b is a control unit that controls an operation input operation directed to the operation input unit 6a. For example, the input control unit 11b controls an operation for receiving an operation input to the operation screen.

The operation control unit 11d is a control unit that controls a print output operation, a scan operation, a facsimile communication operation, and the like in the MFP 10.

The settings processing unit 11e is a processing unit that sets the settings information relating to operations in the MFP 10. The settings processing unit 11e sets the settings information, in accordance with at least a reception instruction including an instruction command transmitted from the cloud server 50 and/or an operation input instruction by a user's finger (an operation input instruction using the operation panel unit 18 or the like).

The reset control unit 11f is a processing unit that performs a process of (automatically) resetting the settings information set by the settings processing unit 11e in response to the elapse of a predetermined non-instruction period M1 (this process is also called an auto reset). As will be described later in detail, in a case where an operation of the MFP 10 by a voice instruction is started, the reset control unit 11f prevents execution (generation) of an auto reset.

The sleep control unit 11g is a processing unit that performs a process of putting the MFP 10 into a sleep state (hereinafter also referred to as an “auto sleep”) in response to the elapse of a certain non-instruction period M2.

The authentication control unit 11h is a processing unit that performs a user authentication process. The authentication control unit 11h also performs a process of switching the MFP 10 from a login state of a certain user U1 to a logout state (of the user U1) in response to the elapse of a certain non-instruction period M3 (this process will be hereinafter also referred to as an “auto logout”).

In the first embodiment, the above non-instruction periods M1, M2, and M3 are the same (each period being 30 seconds, for example). However, the non-instruction periods M1, M2, and M3 are not necessarily the same as one another, but may be different from one another. For example, the period M1 may be 30 seconds, the period M3 may be 60 seconds, and the period M2 may be 90 seconds.

Further, in the first embodiment, these periods M1, M2, M3 are measured by the same timer 11p (not shown) in the MFP 10, and, when an instruction is accepted by the MFP 10, the timer 11p is reset to zero (the measured times relating to the periods M1, M2, and M3 are all reset to zero).

### 1-3. Configuration of the Cloud Server 50

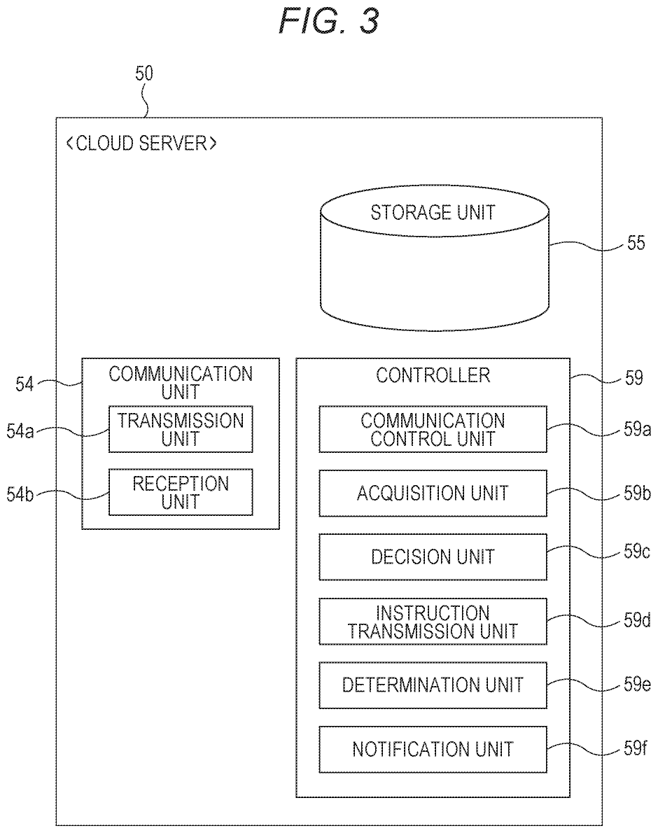

Referring now to FIG. 3. the configuration of the cloud server 50 is described. FIG. 3 is a diagram showing the functional blocks of the cloud server 50.

As shown in the functional block diagram in FIG. 3, the cloud server 50 includes a communication unit 54, a storage unit 55, and a controller 59, and achieves various functions by causing the respective components to operate in combination.

The communication unit 54 can perform network communication via the network 108. In the network communication, various kinds of protocols such as TCP/IP (Transmission Control Protocol/Internet Protocol) and HTTP (HyperText Transfer Protocol) are used, for example. Using the network communication the cloud server 50 can exchange various kinds of data with a desired communication destination (such as the MFP 10 and the audio device 70). The communication unit 54 includes a transmission unit 54a that transmits various kinds of data, and a reception unit 54b that receives various kinds of data.

The storage unit 55 is formed with a storage device such as a semiconductor memory (a RAM or and a hard disk drive (HDD) or the like.

The controller (a control unit) 59 in FIG. 3 is a control device that is included in the cloud server 50, and comprehensively controls the cloud server 50. The controller 59 is formed as a computer system including a CPU and various kinds of semiconductor memories (a RAM and a ROM). The controller 59 forms various kinds of processing units, as the CPU executes a predetermined program (an OS, applications, or the like) stored in a storage unit (a semiconductor memory or the like). Note that the program (more specifically, a program module group) may be recorded in a portable recording medium (such as a CD-ROM or a USB memory), be read out from the recording medium, and be installed into the cloud server 50. Alternatively, the program may be transmitted via a network or the like, and be installed into the cloud server 50.

Here, “MFP cooperating cloud application software” Q5 (application software (an application for servers) for operating the MFP 10 by voice, in cooperation with the audio device 70 and the cloud server 50) is installed as the program. Note that the “MFP cooperating cloud application software” (Q5) is also referred to as an “MFP cooperating cloud application” or an “MFP cooperating cloud app”.

The controller 59 executes the program, to form various kinds of processing units including a communication control unit 59a, an acquisition unit 59b, a decision unit 59c, an instruction transmission unit 59d, a determination unit 59e, and a notification unit 59f.

The communication control unit 59a is a processing unit that controls communication operations with the MFP 10 and the audio devices 70, in cooperation with the communication unit 54 and the like.

The acquisition unit 59b is a processing unit that acquires, from the audio device 70, a voice instruction for operating the MFP 10, in cooperation with the communication control unit 59a and the like. The voice instruction is issued by the user in a conversation between the user and the audio device 70. More specifically, the acquisition unit 59b can perform a natural language analyzing process on the voice (input voice) received from the audio device 70, and interpret (understand) the user instruction (voice instruction) issued through the input voice.

The decision unit 59c is a processing unit that decides whether to transmit an instruction command based on a voice instruction to the MFP 10, in response to the voice instruction.

The instruction transmission unit 59d is a processing unit that generates an instruction command based on a voice instruction acquired by the acquisition unit 59b, and transmits the instruction command to the MFP 10. The instruction transmission unit 59d transmits the instruction command to the MFP 10, in cooperation with the communication control unit 59a and the like. Further, on the condition that the decision unit 59c decides that the instruction command is to be transmitted to the MFP 10 in response to a voice instruction from the audio device 70, the instruction transmission unit 59d transmits the instruction command to the MFP 10.

The determination unit 59e is a processing unit that determines whether a conversation is being performed between the user and the audio device 70. In other words, the determination unit 59e is a processing unit that determines whether a cooperation process among the MFP 10, the cloud server 50, and the audio device 70 is being continued. Specifically, the determination unit 59e detects the start of a conversation between the user and the audio device 70, and also detects the end of the conversation. In short, the determination unit 59e determines whether a conversation between the user and the audio device 70 is being continued. The determination unit 59e is also regarded as a detection unit that detects the start and/or the end of a conversation.

The notification unit 59f is a processing unit that notifies the MFP 10 of an “auto reset prevention instruction” (an instruction to prevent execution of auto reset), in cooperation with the communication control unit 59a and the like.

Here, the cloud server 50 is not necessarily formed with a single server device (computer device), and may be formed with a plurality of server devices. In that case, some or all of the plurality of processing units may be formed with different server devices from one another. Alternatively, the processes to be performed by the respective processing units may be distributed among server devices, and be then performed by the server devices. In the present application, not only a single server device but also a server device group formed with a plurality of server devices is referred to as a “cloud server”.

### 1-4. Outline of Operation

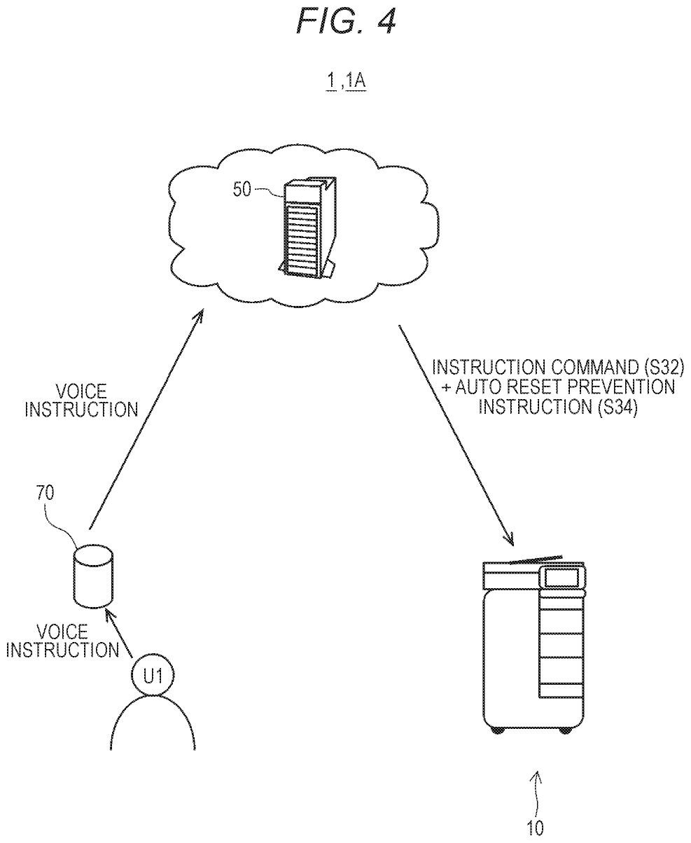

Next, an outline of operation in the system 1 is described with reference to FIG. 4. FIG. 4 is a conceptual diagram showing an outline of operation according to the first embodiment.

In the image processing system 1, a cooperation process among the MFP 10, the cloud server 50, and the audio device 70 is performed, to operate the MFP 10. Specifically, after the user logs in to the MFP 10 through the operation panel unit 18 (and/or an ID card authentication device or the like), a setting process or the like relating to a job in the MFP 10 is performed in accordance with a voice instruction using the audio device 70 (an instruction via the cloud server 50). In this embodiment, the MFP 10 accepts a setting process based on an operation instruction using the operation panel unit 18 of the MFP 10 (an instruction issued not via the cloud server 50), in addition to a setting process based on a voice instruction using the audio device 70. The description herein focuses on a setting process or the like based on a voice instruction using the audio device 70.

When the audio device 70 receives a voice input by a user (in other words, a user instruction (a voice instruction) input by voice), the audio device 70 transmits the voice (specifically, voice data) to the cloud server 50. On the basis of the voice data from the audio device 70, the cloud server 50 acquires the user instruction (a user instruction regarding a setting process or the like for the MFP 10). Specifically, the cloud server 50 performs a natural language analyzing process or the like on the voice data received from the audio device 70, grasps (understands) the contents of the user's voice instruction, and acquires (identifies) the user instruction. In this manner, the cloud server 50 acquires, from the audio device 70, a voice instruction for operating the MFP 10 (specifically, a voice instruction issued by the user in a conversation between the user and the audio device 70).

The cloud server 50 then transmits an instruction command (such as a setting command related to a job in the MFP 10) based on the user instruction (the voice instruction), to the MFP 10.

The MFP 10 stores the settings information transmitted from the cloud server 50 into the storage unit 5 (FIG. 2) in the MFP 10, and, on the basis of the settings information stored in the storage unit 5 in the MFP 10, performs a setting process relating to the MFP 10.

Here, the MFP 10 has an “auto reset function”. Specifically, the MFP 10 resets the settings information stored (temporarily) in the storage unit 5 of the MFP 10 (or returns the set values relating to the respective setting items to the default values (initial values)), in response to the elapse of the predetermined non-instruction period M1 (30 seconds, for example). In this embodiment, during the predetermined non-instruction period M1, there are no user instructions via the operation panel unit 18 of the MFP 10 (that is, there are no direct operation instructions based on the user's finger or the like moved on the operation panel unit 18), and there are no voice instructions via the audio device 70 and the cloud server 50 (specifically, there are no instruction commands based on the voice instructions).

In the image processing system 1, a process only between the audio device 70 and the cloud server 50 might be performed over a relatively long period of time during the cooperation process among the three sides 10, 50, and 70 (in other words, any instruction is not issued to the MFP 10 over a relatively long period of time). For example, in a case Where a considerable period of time is required to perform a process for checking the settings contents between the user and the audio device 70, any instruction from the cloud server 50 to the MFP 10 is not transmitted during the considerable period of time.

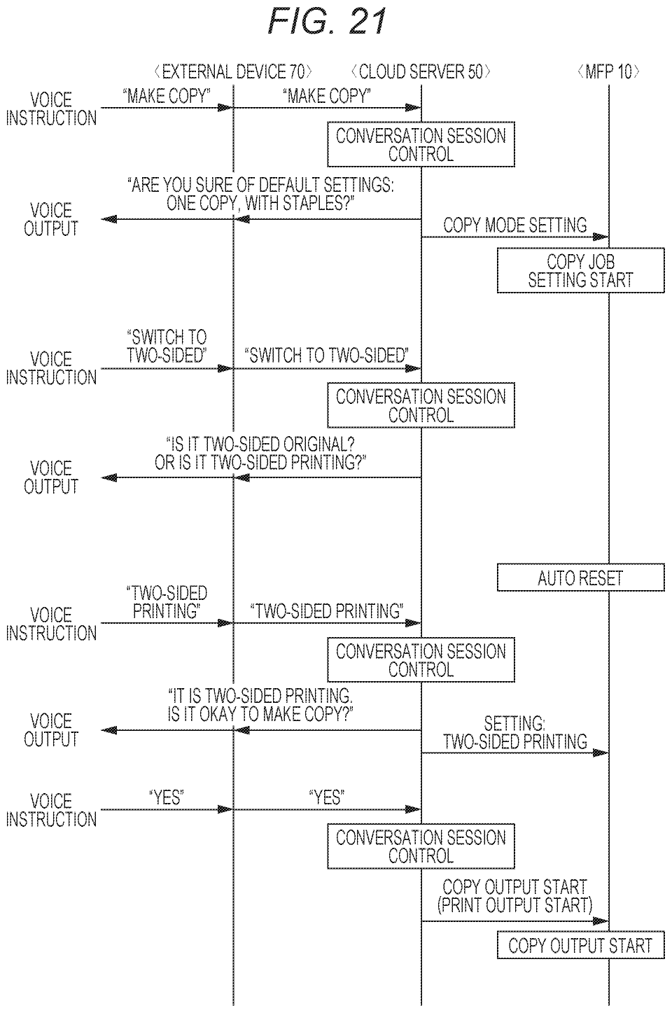

FIG. 21 is a diagram showing such a situation. FIG. 21 is a timing chart showing information exchange and the like among the audio device 70, the cloud server 50, and the MFP 10. FIG. 21 shows a case where the above described situation occurs in a system according to a comparative example.

In FIG. 21, the user issues a voice instruction “Switch to two-sided.”, after issuing a voice instruction “Make a copy.”. In this case, even if the cloud server 50 can understand that “two-sided” is an instruction relating to a setting process, the cloud server 50 cannot determines whether the voice instruction “two-sided” refers to a “two-sided original” or “two-sided printing”. Here, the “two-sided original” means that the set value of the setting item “reading side(s) of the original” is set to “two-sided” (not “one-sided”), and “two-sided printing” means that the set value of the setting item “output side(s) of the print output sheet” is set to “two-sided” (not “one-sided”).

In response to that, the cloud server 50 sets the set value “two-sided”, and determines that there exist the respective set values relating to the two setting items (“reading side(s) of the original” and “output side(s) of the print output sheet”). The cloud server 50 also determines that the contents of the user instruction cannot be identified (or that the cloud server 50 has failed to identify the contents of the instruction). That is, the cloud server 50 determines the user instruction to be unclear. The cloud server 50 then inquires of the user which of the two set values (two-sided original and two-sided printing) is intended. Specifically, the cloud server 50 transmits character string information indicating “Is it a two-sided original or two-sided printing?” to the audio device 70, and causes the audio device 70 to make a voice output. In response to this inquiry, the user replies with a desired option (“two-sided printing”, for example). In this manner, the cloud server 50 can grasp the user's intention.

However, it takes a considerable period of time to make such a checking inquiry and receive a reply to the inquiry. Furthermore, during such a period, any instruction is given to the MFP 10. Therefore, there is a high possibility that the predetermined non-instruction period M1 will elapse in this case.

In such a case, the MFP 10 determines that the predetermined non-instruction period M1 has elapsed, and resets the settings contents temporarily stored in the storage unit 5 in the MFP 10. That is, in spite of the fact that the setting process by a voice instruction from the user is actually being continued, an auto reset occurs in the MFP 10 (see a middle portion of FIG. 21). When an auto reset occurs, the user's convenience decreases, as the user is required to redo the setting from the beginning, for example. It is preferable that such unnecessary auto resets do not occur.

In this embodiment, on the other hand, the process described below is performed.

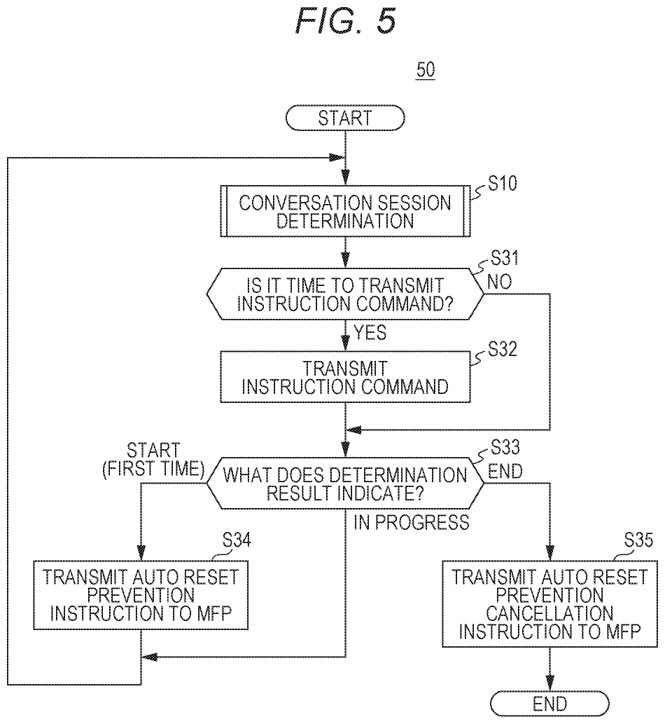

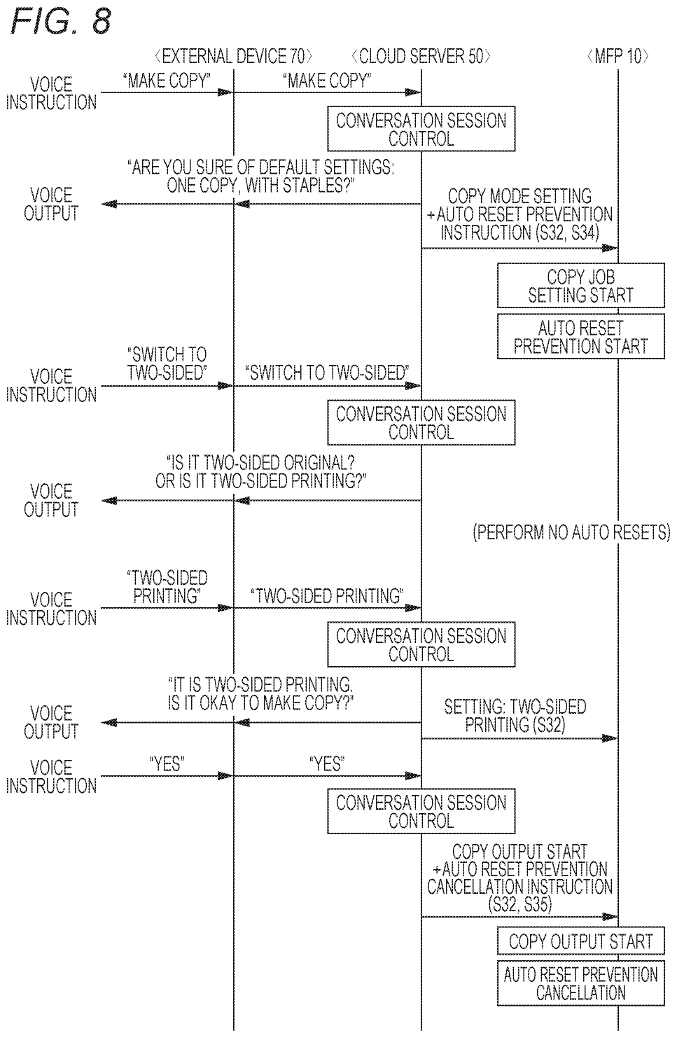

Specifically, in a case where operation of the MFP 10 is started by a voice instruction, the cloud server 50 transmits, to the MFP 10, a notification for preventing execution of an auto reset in the MFP 10. More specifically, the cloud server 50 notifies the MFP 10 of an “auto reset prevention instruction” (an instruction indicating that execution of an auto reset should be prevented) (see FIG. 4). To be more specific, in a case where the cloud server 50 detects the start of a conversation between the user and the audio device 70 (a conversation relating to an operation of the MFP 10), the cloud server 50 notifies the MFP 10 of an “auto reset prevention instruction” (step S34 described later (see FIGS. 5 and 8)). The MFP 10 (specifically, the reset control unit 11f (FIG. 2)) then prevents execution of an auto reset, in accordance with the received auto reset prevention instruction. Specifically, as any auto reset is not performed even after the predetermined non-instruction period M1 has elapsed, execution of an auto reset is prevented. For example, the MFP 10 ignores the result of time measurement by the timer 11p that measures the non-instruction period M1 relating to auto resets, and resets the result of time measurement, so that any auto reset is not performed. Alternatively, the timer 11p is not operated, for example, so that any auto reset is not performed.

Such an auto reset prevention process can prevent an unnecessary occurrence of an auto reset in the MFP 10.

To be more specific, the MFP 10 prevents execution of an auto reset, while a conversation between the user and the audio device 70 is being continued.

Specifically, when the end of a conversation is detected after the cloud server 50 notifies the MFP 10 of an auto reset prevention instruction at the start of the conversation, the cloud server 50 in turn notifies the MFP 10 of an “auto reset prevention cancellation instruction” (an instruction for canceling an auto reset prevention instruction). In accordance with the auto reset prevention cancellation instruction, the MFP 10 (the reset control unit 11f) cancels the prevention of execution of an auto reset. After that, the MFP 10 performs an auto reset as soon as the predetermined non-instruction period M1 elapses, as usual.

Various kinds of information from the cloud server 50 to the MFP 10 (such as an instruction command, a dummy command (described later), an auto reset prevention instruction, and an auto reset prevention cancellation instruction) are transmitted by a so-called push technology (a communication technology by which a communication request is started from the information sender (such as a server)). An example of the push technology may be a technology using various kinds of protocols (such as message notifying protocols) like Message Queuing Telemetry Transport (MQTT) or the like. Alternatively, the push technology may be a technology for performing pseudo push transmission using a polling technique or the like (such as a push technology using a configuration in which bidirectional communication is triggered by communication from the MFP 10 to the cloud server 50). For example, a long polling technique (COMET or the like), a web socket (WebSocket) technique, or the like may be used.

In the description below, the above operation (such as an auto reset prevention operation and the like) will be described in greater detail.

### 1-5. Specific Operations

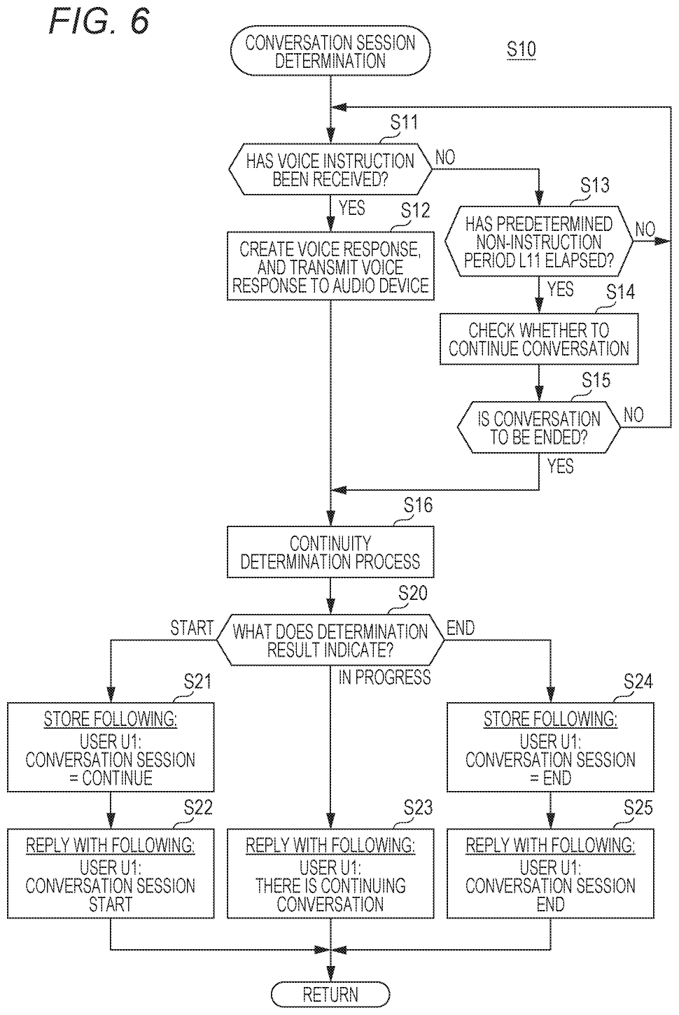

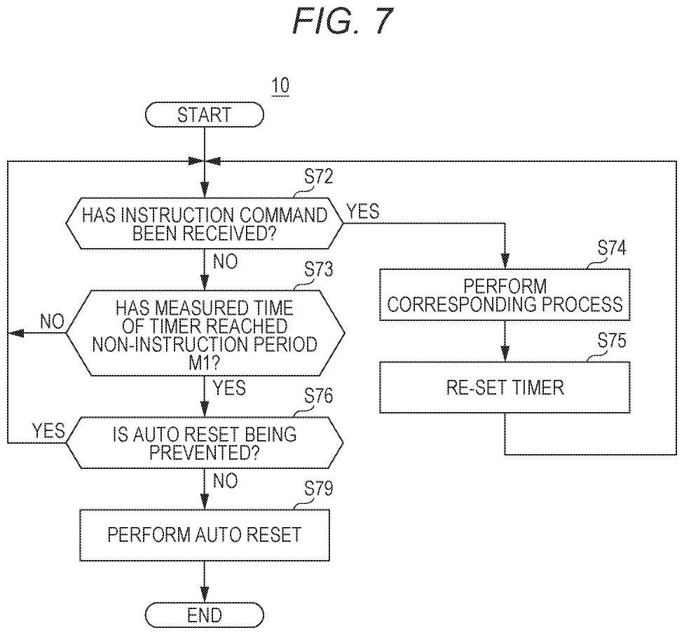

FIGS. 5 and 6 are flowcharts showing operation of the cloud server 50. FIG. 7 is a flowchart showing operation of the MFP 10. FIG. 8 is a timing chart showing example operations of the respective apparatuses 10, 50, and 70 in the image processing system 1. In the description below, operation of the image processing system 1 will be described in detail, with reference to these drawings and the like.

In a conversation session determination routine in step S10 (see FIG. 5, as well as FIG. 6), the cloud server 50 receives a voice instruction from the audio device 70 (step S11). The cloud server 50 generates a voice response in accordance with a predetermined conversation generation logic, and transmits the voice response to the audio device 70 (step S12). After that, the process moves on to step S16.

For example, when the cloud server 50 receives a voice instruction “Make a copy.” from the user U1 via the audio device 70, the cloud server 50 understands that a copy instruction (a copy setting instruction) has been received. The cloud server 50 then generates a voice response “Are you sure of the default settings: one copy, with staples, and the like?”, and transmits the voice response to the audio device 70 (see FIG. 8). As a result, the voice response is output as a voice by the audio device 70.

Alternatively, when the cloud server 50 receives a voice instruction “Switch to two-sided.” from the user U1 via the audio device 70, the cloud server 50 determines that the instruction contents (the setting item) are unclear. The cloud server 50 generates a voice response “Is it a two-sided original or two-sided printing?”, and transmits the voice response to the audio device 70 (see FIG. 8). As a result, the voice response is output as a voice by the audio device 70.

Alternatively, when the cloud server 50 receives a voice instruction “Two-sided printing” from the user U1 via the audio device 70, the cloud server 50 understands the instruction contents (setting the setting item the “output side(s) of the print output sheet” to “two-sided”). The cloud server 50 then generates a voice response “Are you sure of two-sided printing. Is it okay to make a copy?”, and transmits the voice response to the audio device 70 (see FIG. 8). As a result, the voice response is output as a voice by the audio device 70.

In a case where any voice instruction is not received over a predetermined period L11 (proceeding from step S13 to step S14), the cloud server 50 checks with the user whether to continue the conversation. Specifically, the cloud server 50 generates a voice response to prompt the user to speak again (such as “Would you like to end?”) (an end checking voice response), and transmits the voice response to the audio device 70. In a case where the audio device 70 does not receive any response (voice input) from the user in response to a voice output of the end checking voice response (and in a case where a response “Yes” (a response indicating an end) is obtained), the cloud server 50 determines to end the conversation, and moves from step S15 on to step S16. Conversely, in a case where the intention to continue the conversation is confirmed, the process returns from step S15 to step S11.

In step S16, the cloud server 50 determines the state of the conversation. Specifically, a check is made to determine whether the conversation is at the start point, at the end point, or in the middle (the middle of the conversation period). The cloud server 50 determines that the period from the start point to the end point of the conversation is the duration of the conversation period.

For example, in a case where a voice instruction is received when a conversation has not started, the cloud server 50 determines that the conversation has started. In other words, the cloud server 50 detects the start of the conversation. At the start of the conversation, the cloud server 50 sets the conversation session state information relating to the user U1 who has logged in to “continued” (step S21), and notifies the caller routine that the start of the conversation session has been detected (step S22).

In a case where an end determination condition is satisfied after the conversation has been started, the cloud server 50 determines that the conversation has ended. In other words, the cloud server 50 detects the end of the conversation. The end determination condition may be that an explicit end instruction (a voice instruction) has been issued, or that any voice instruction from the audio device 70 has not been issued and any voice instruction has not been issued in response to the end checking voice response over a predetermined period of time, for example. Alternatively, the end of the conversation may be detected only from absence of the end checking voice response and absence of any voice instruction from the audio device 70 over a predetermined period of time.

At the end of the conversation, the cloud server 50 (specifically, the processing routine in step S10) sets the conversation session state information relating to the user U1 who has logged in to “end” (step S24), and notifies the caller routine that the end of the conversation session has been detected (step S25).

During the period between the start time of the conversation and the end time of the conversation, the cloud server 50 determines that the conversation is in progress.

During the conversation, the cloud server 50 maintains the conversation session state information relating to the user U1 who has logged in at “continued”, and notifies the caller routine that the conversation is being continued (the conversation session is being continued (step S23).

After the processing by such a conversation session determination routine (step S10), the cloud server 50 determines whether to transmit, to the MFP 10, an instruction command based on a voice instruction received from the audio device 70, in response to the voice instruction (step S31 (FIG. 5)). In other words, a check is made to determine whether the present time is the time to transmit an instruction command based on the voice instruction to the MFP 10.

If it is determined that an instruction command based on the voice instruction is to be transmitted to the MFP 10 in response to the voice instruction, the cloud server 50 transmits the instruction command to the MFP 10 (step S32). Steps S31 and S32 will be described later.

In the next step S33, a branching process depending on the result of the determination in step S10 is performed.

Further, in a case where the start of the conversation is detected by the conversation session determination routine (step S10), the process proceeds from step S33 to step S34, and the cloud server 50 transmits an “auto reset prevention instruction” to the MFP 10. After that, the process returns to step S10.

Further, in a case where the end of the conversation is detected by the conversation session determination routine (step S10), the process proceeds from step S33 to step S35, and the cloud server 50 transmits an “auto reset prevention cancellation instruction” to the MFP 10. After that, the process returns to step S10.

In a case where continuance of the conversation is detected by the conversation session determination routine (step S10), the cloud server 50 transmits neither an “auto reset prevention instruction” nor an “auto reset prevention cancellation instruction”, and returns to step S10.

For example, when receiving a voice instruction “Make a copy.” from the user U1 via the audio device 70 before a conversation has started, the cloud server 50 detects the start of a conversation (S16, S21, and S22). The cloud server 50 also determines that it is time to transmit an instruction command based on the voice instruction (specifically, a command for performing a setting operation relating to a “copy” job (“copy setting”)) (YES in step S31). The cloud server 50 then transmits a “copy setting” command to the MFP 10 (step S32), and also transmits an “auto reset prevention instruction” to the MFP 10 (step S34).

Further, when the cloud server 50 receives a voice instruction “Switch to two-sided.” from the user U1 via the audio device 70 while the conversation is being continued, the cloud server 50 detects the continuance of the conversation (S16 and S23). Because the instruction contents of the voice instruction “Switch to two-sided.” are unclear, the cloud server 50 also determines that it is not the time to transmit an instruction command based on the voice instruction to the MFP 10 (NO in step S31). In this case, the cloud server 50 does not transmit any command (an instruction command, an auto reset prevention instruction command, or an auto reset prevention cancellation instruction command) to the MFP 10.

Further when the cloud server 50 receives a voice instruction “Yes” from the user U1 via the audio device 70 in response to a question (a voice response) from the cloud server 50 and the audio device 70 asking “Is it okay to make a copy?” after the start of the conversation, the cloud server 50 determines the voice response to be an explicit conversation end instruction, and detects the end of the conversation (S16, S24, and S25). The cloud server 50 also determines that it is time to transmit an instruction command based on the voice instruction (specifically, a command for starting an output operation relating to a “copy” job (“copy output stall”)) (YES in step S31). The cloud server 50 then transmits a “copy output start” command to the MFP 10 (step S32), and also transmits an “auto reset prevention cancellation instruction” to the MFP 10 (step S35).

Meanwhile, when the MFP 10 receives an instruction command (YES in step S72 (FIG. 7)), the MFP 10 performs a process corresponding to the instruction command (step S74), and again sets the timer 11p for auto resets (step S75). Specifically, the MFP 10 resets the time-measuring counter of the timer 11p to zero (resets the measured time relating to the predetermined non-instruction period M1), and then starts (restarts) time measurement with the timer 11p. Further, when the predetermined non-instruction period M1 has elapsed without reception of any instruction command by the MFP 10 (NO in step S72, and YES in step S73), the MFP 10 determines whether auto resets are being prevented (step S76). During the period from reception of an “auto reset prevention instruction” till reception of an “auto reset prevention cancellation instruction”, it is determined that auto resets are being prevented. On the other hand, before reception of an “auto reset prevention instruction” or after reception of an “auto reset prevention cancellation instruction”, it is determined that auto resets are not being prevented (prevention cancelled).

Specifically, after receiving an “auto reset prevention instruction”, the MFP 10 prevents execution of an auto reset in accordance with the auto reset prevention instruction (the start of prevention). The MFP 10 determines that auto resets are being prevented, and prevents execution of an auto reset. More specifically, even in a case where the predetermined non-instruction period M1 (30 seconds, for example) has elapsed (YES in step S73), if it is determined that auto resets are being prevented (YES in step S76), the MFP 10 does not perform any auto reset (step S79; see also FIG. 8). Accordingly, as can be seen from a comparison between FIG. 8 and FIG. 21, even if the predetermined non-instruction period M1 has elapsed since a voice instruction “Make a copy.”, any auto reset does not occur. Thus, it is possible to prevent the occurrence of unnecessary auto resets in the MFP 10.

Further, when receiving an “auto reset prevention cancellation instruction”, the MFP 10 cancels auto reset execution prevention, in accordance with the auto reset prevention cancellation instruction. As a result, in a case where the predetermined non-instruction period M1 has elapsed since the cancellation time, the MFP 10 performs an auto reset (step S79). Thus, it is possible to appropriately enable the auto reset function. during a period in which any conversation is not being performed.

As described above, in the operation according to the first embodiment, execution of an auto reset is prevented in a case where operation of the MFP 10 is started by a voice instruction (see FIG. 8 and others). More specifically, in a case where the start of a conversation is detected, the cloud server 50 notifies the MFP 10 of an auto reset prevention instruction (step S34), and the MFP 10 prevents execution of an auto reset, in accordance with the auto reset prevention instruction. Thus, it is possible to prevent the occurrence of unnecessary auto resets in the MFP 10.

In the above embodiment, execution of auto resets is prevented, as any auto reset is not performed (also expressed as “non-execution of auto resets” or “invalidation of auto resets”) even after the predetermined non-instruction period M1 has elapsed. However, the present technology is not limited to this. For example, the timing to perform an auto reset may be delayed, to prevent execution of the auto reset. Specifically, the MFP 10 (the reset control unit 11f) may change (extend) the duration of the predetermined non-instruction period M1 from the default value (30 seconds, for example) to a different value (five minutes, for example; a greater value than the default value), to delay the timing to start an auto reset. By doing so, the MFP 10 may prevent execution of auto resets.

Further, in the first embodiment, the MFP 10 determines whether the predetermined non-instruction periods M1, M2, and M3 have elapsed, on the basis of the time measured by the single timer 11p. However, the present technology is not limited to this. For example, the MFP 10 may determine whether the respective non-instruction periods M1, M2, and M3 have elapsed, on the basis of the times measured by a plurality of timers.

Furthermore, whether or not the elapses of the non-instruction periods M1, M2, and M3 are measured with a single timer or a plurality of timers, execution of auto resets may be prevented in accordance with an auto reset prevention instruction, and execution of an auto sleep and/or execution of an auto logout may also be prevented as described below.

Specifically, in a case where the MFP 10 is notified of an auto reset prevention instruction, the MFP 10 may prevent not only execution of an auto reset but also execution of an “auto sleep”, in accordance with the auto reset prevention instruction. More specifically, in a case where the MFP 10 is notified of an auto reset prevention instruction, the MFP 10 may also prevent execution of an auto sleep, regarding that an auto sleep prevention instruction has also been issued. Here, an “auto sleep” is a process of causing the MFP 10 to (automatically) entering a sleep state, in response to the elapse of the non-instruction period M2. The non-instruction period M2 may have the same length as or a different length from the predetermined non-instruction period M1 relating to auto resets.

Alternatively, in a case where the start of a conversation is detected, the cloud server 50 may (explicitly) notify the MFP 10 of an “auto sleep prevention instruction” (an instruction to prevent execution of an auto sleep), as well as an “auto reset prevention instruction”. The MFP 10 may then prevent execution of an auto sleep, in accordance with the auto sleep prevention instruction.

Alternatively, prevention of execution of an auto sleep may be realized by non-execution of an auto sleep, or may be realized by an extension of the period M2. Further, each of the above modifications may be applied in a case where an “auto reset” and an “auto sleep” are linked to each other (or where the non-instruction periods M1 and M2 have the same value, for example). Alternatively, each of the modifications may be applied in a case where an “auto reset” and an “auto sleep” function separately from each other (or where the non-instruction periods M1 and M2 have different values from each other).

Further, in a case where the MFP 10 is notified of an auto reset prevention instruction, the MFP 10 may prevent not only execution of an auto reset (and an auto sleep) but also execution of an “auto logout”, in accordance with the auto reset prevention instruction. More specifically, in a case where the MFP 10 is notified of an auto reset prevention instruction, the MFP 10 may also prevent execution of an auto logout (an auto sleep), regarding that an auto logout (and auto sleep) prevention instruction has also been issued. Here, an “auto logout” is a process of causing the MFP 10 to (automatically) switching from a user login state to a logout state, in response to the elapse of the non-instruction period M3. The non-instruction period M3 may have the same length as or a different length from the predetermined non-instruction period M1 relating to auto resets.

Alternatively, in a case where the start of a conversation is detected, the cloud server 50 may (explicitly) notify the MFP 10 of an “auto logout prevention instruction” (an instruction to prevent execution of an auto logout), as well as an “auto reset prevention instruction” (and an auto sleep prevention instruction). The MFP 10 may then prevent execution of an auto logout, in accordance with the auto logout prevention instruction.

Alternatively, prevention of execution of an auto logout may be realized by non-execution of an auto logout, or may be realized by an extension of the period M3. Further, each of the above modifications may be applied in a case where an “auto reset” and an “auto logout” are linked to each other (or where the non-instruction periods M1 and M3 have the same value, for example). Alternatively, each of the modifications may be applied in a case where an “auto reset” and an “auto logout” function separately from each other (or where the non-instruction periods M1 and M3 have different values from each other). Further, each of the above modifications may be applied in a case where an “auto reset”, an “auto sleep”, and an “auto logout” are linked to one another (or where the non-instruction periods M1, M2, and M3 have the same value, for example). Alternatively, each of the modifications may be applied in a case where an “auto reset”, an “auto sleep”, and an “auto logout” function separately from one another (or where the non-instruction periods M1, M2, and M3 have different values from one another).

### 2. Second Embodiment

A second embodiment is a modification of the first embodiment. The description below will focus on the differences from the first embodiment.

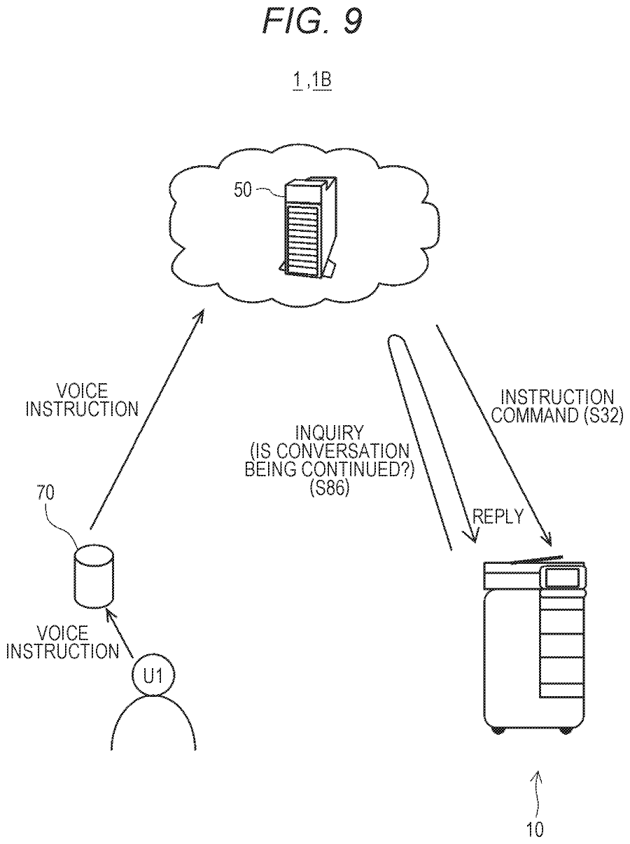

FIG. 9 is a conceptual diagram showing operation of an image processing system 1 (1B) according to the second embodiment. As shown in FIG. 9, in the second embodiment, the MFP 10 inquires of the cloud server 50 whether a conversation between the user and the audio device 70 is being continued. In a case where the MFP 10 receives a reply “conversation being continued” in response to the inquiry, the MFP 10 prevents execution of an auto reset.

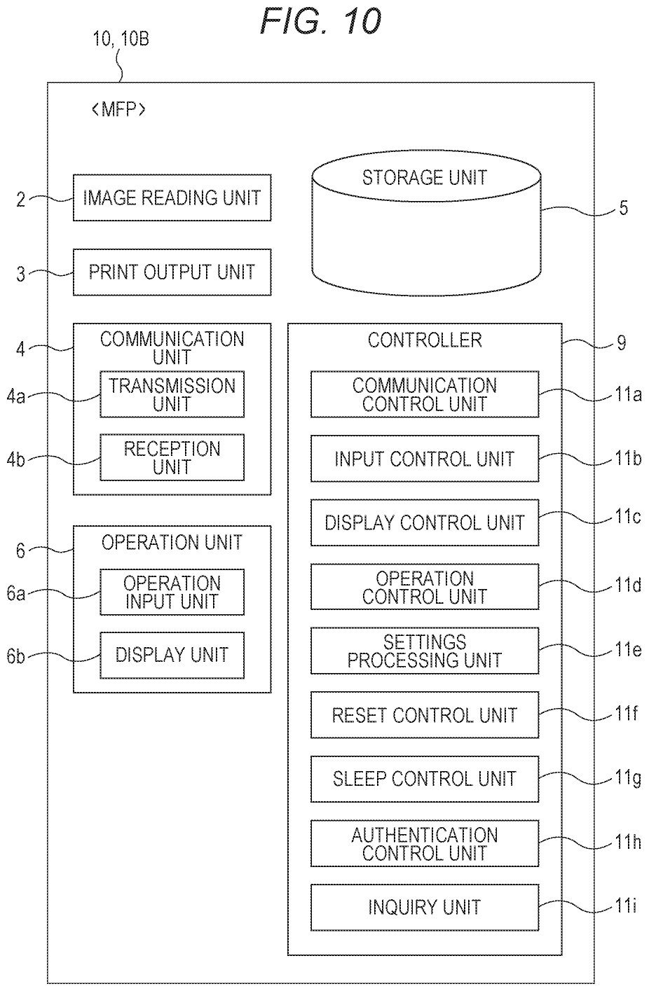

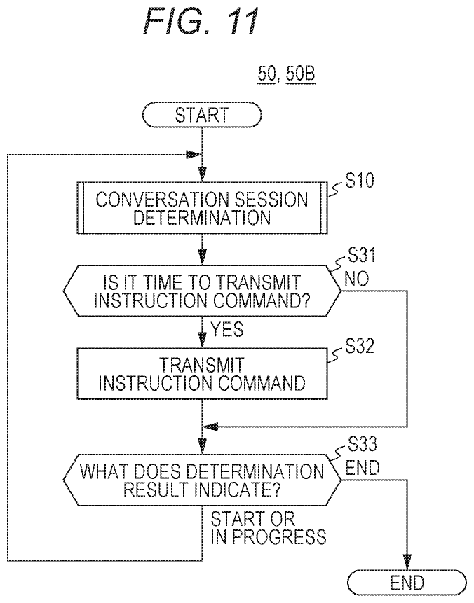

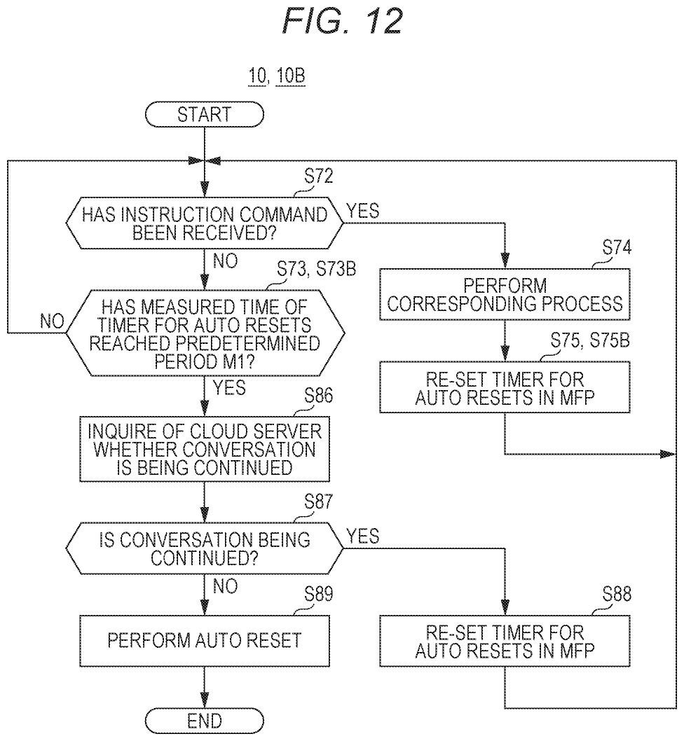

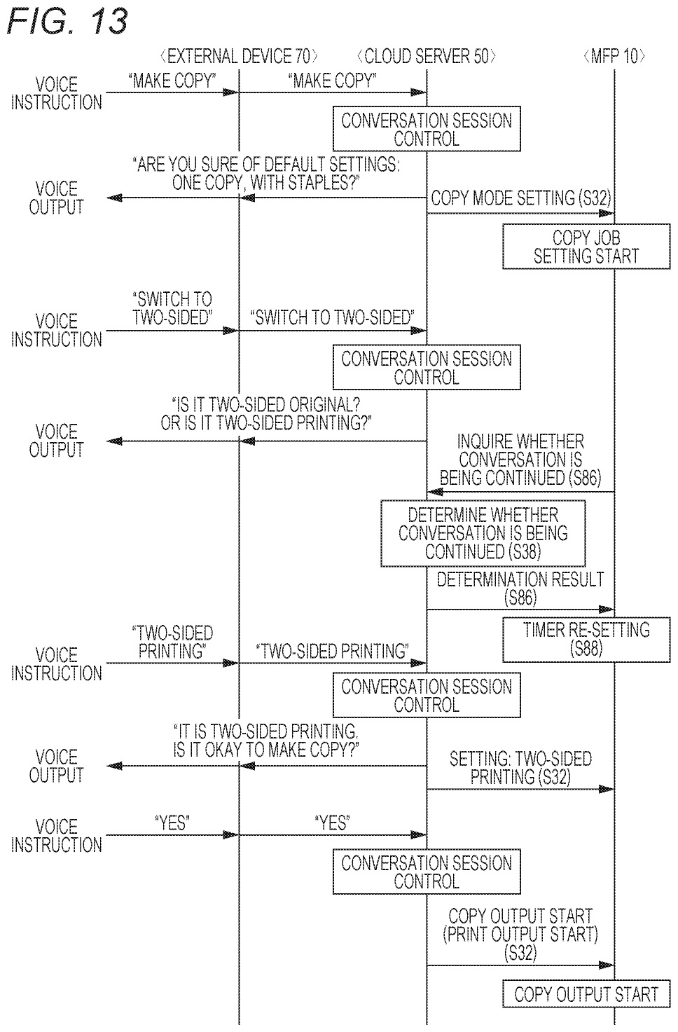

FIG. 10 is a diagram showing the functional blocks of the MFP 10 (10B) according to the second embodiment. FIG. 11 is a flowchart showing operation of the cloud server 50 (50B) according to the second embodiment. FIG. 12 is a flowchart showing operation of the MFP 10B according to the second embodiment. FIG. 13 is a diagram showing an example operation of the image processing system 1 (1B) according to the second embodiment.

As shown in FIG. 11 and the others, the operation of the cloud server 50 according to the second embodiment differs from the cloud server 50 according to the first embodiment, in not performing the processes in steps S34 and S35 (FIG. 5) (that is, neither transmitting an auto reset prevention instruction, nor transmitting an auto reset prevention cancellation instruction). Note that the cloud server 50 performs the operation in step S10 (see FIG. 6) and the like, and manages information about conversation continuity, as in the first embodiment.

Further, in a case where the predetermined non-instruction period M1 has elapsed (YES in step S73B (FIG. 12)), the MFP 10 (specifically, an inquiry unit 11i (see FIG. 10)) according to the second embodiment does not immediately perform an auto reset, and inquires of the cloud server 50 whether a conversation using the audio device 70 and the cloud server 50 or the like is being continued (step S86 (FIG. 12)). In a case where a reply indicating that any conversation is not being continued is received from the cloud server 50 (NO in step S87), the MFP 10 performs an auto reset (step S89). In a case where a reply indicating that a conversation is being continued is received from the cloud server 50 (YES in step S87), on the other hand, the MFP 10 prevents execution of an auto reset (step S88 (see also FIG. 13)). Specifically, the timer 11p for auto resets is set again. Specifically, the MFP 10 resets the counter of the timer 11p for auto resets to zero (in other words, invalidates the elapse of the predetermined non-instruction period M1), and then starts (restarts) time measurement.

For example, as shown in FIG. 13, in a case where the timer 11p for auto resets in the MFP 10 has counted up (where the predetermined non-instruction period M1 has elapsed) after a voice instruction “Switch to two-sided.”, the MFP 10 inquires of the cloud server 50 whether a conversation is being continued (step S86 (see also FIG. 12)).

Receiving the inquiry from the MFP 10, the cloud server 50 answers (replies) to the MFP 10, regarding whether a conversation is being continued. Specifically, the cloud server 50 returns, to the MFP 10, the determination result of the latest determination process (step S10) regarding conversation continuity. Note that this process (a determination result return process or the like) in the cloud server 50 is performed through a different routine (not shown) from that shown in FIG. 11.

When the MFP 10 receives from the cloud server 50 that a conversation is being continued, the MFP 10 invalidates the elapse of the predetermined non-instruction period M1 (timer re-setting or the like), to prevent an auto reset (step S88).

Execution (generation) of an auto reset in the MFP 10 is also prevented through the operation described above. More specifically, the MFP 10 inquires of the cloud server 50 whether a conversation is being continued, and, when a reply indicating that a conversation is being continued is received from the cloud server 50, the MFP 10 prevents execution of an auto reset. Thus, it is possible to prevent the occurrence of unnecessary auto resets in the MFP 10.

In the second embodiment, in a case where a reply indicating that a conversation is being continued is received from the cloud server 50, only the execution of an auto reset is prevented. However, execution of some other operation may be prevented. For example, in a case where a reply indicating that a conversation is being continued is received from the cloud server 50, the MFP 10 may prevent not only execution of an auto reset but also execution of an auto sleep and/or an auto logout. In other words, an execution prevention instruction relating to an auto sleep (and/or an auto logout) may also be regarded as having been issued, and execution of an auto sleep (and/or an auto logout) may also be prevented.

Further, in the second embodiment, an inquiry from the MFP 10 to the cloud server 50 is made every time the predetermined non-instruction period M1 has elapsed since the previous instruction time. However, such an inquiry is not necessarily made at such time intervals. For example, the inquiry may be made every time a predetermined period L12 (a shorter period than the period M1) has elapsed since the previous instruction time.

### 3. Third Embodiment

A third embodiment is a modification of the first embodiment. The description below will focus on the differences from the first embodiment.

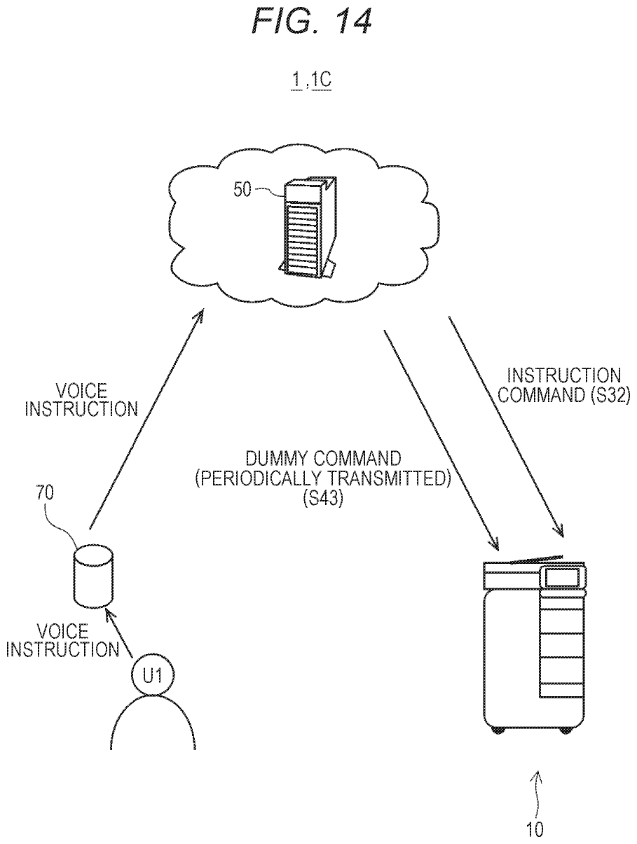

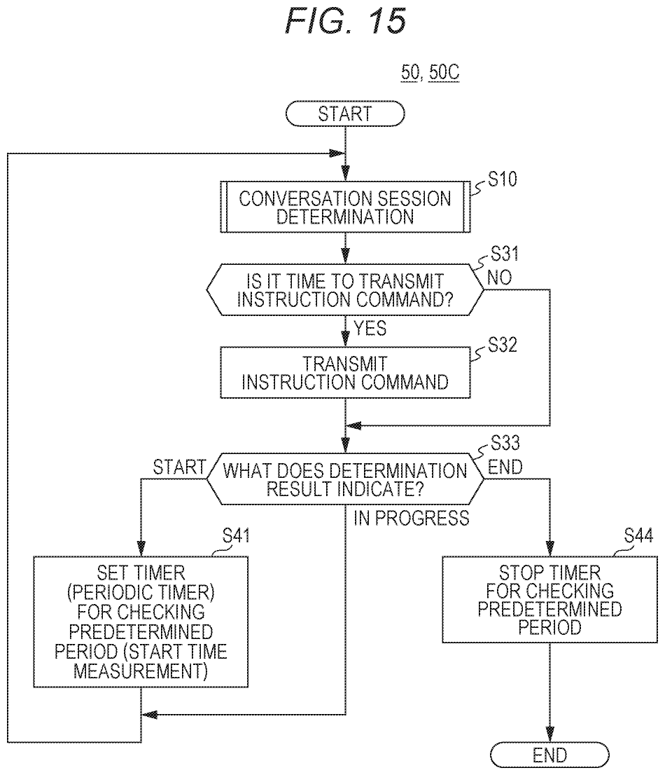

FIG. 14 is a conceptual diagram showing operation of an image processing system 1 (1C) according to the third embodiment. In the third embodiment, a dummy command (described later) is used as a notification for preventing execution of an auto reset in the MFP 10. Specifically, as shown in FIG. 14, in the third embodiment, while a conversation is being continued between the user and the audio device 70, a dummy command (described later) is transmitted from the cloud server 50 to the MFP 10 periodically (at intervals of a predetermined time L13 (described later)) (step S43, see also FIG. 15). When a dummy command is received, the MFP 10 determines that an instruction from the user (and an instruction command corresponding to the instruction) has been received. Because of this, the time measured by the timer 11p for auto resets in the MFP 10 does not reach the predetermined non-instruction period M1, and, as a result, execution of an auto reset is prevented.

Here, a “dummy command” is a command that does not have any substantial influence on operation of the MFP 10 even if one is received by the MFP 10. For example, a new command (such as a “dummy instruction”) that is completely different from regular instruction commands (instruction commands such as “copy setting” (a copy mode setting command) and “setting: two-sided printing” (a two-sided printing setting command) described above) that have substantial influence on operations in the MFP 10 is set as a dummy command.

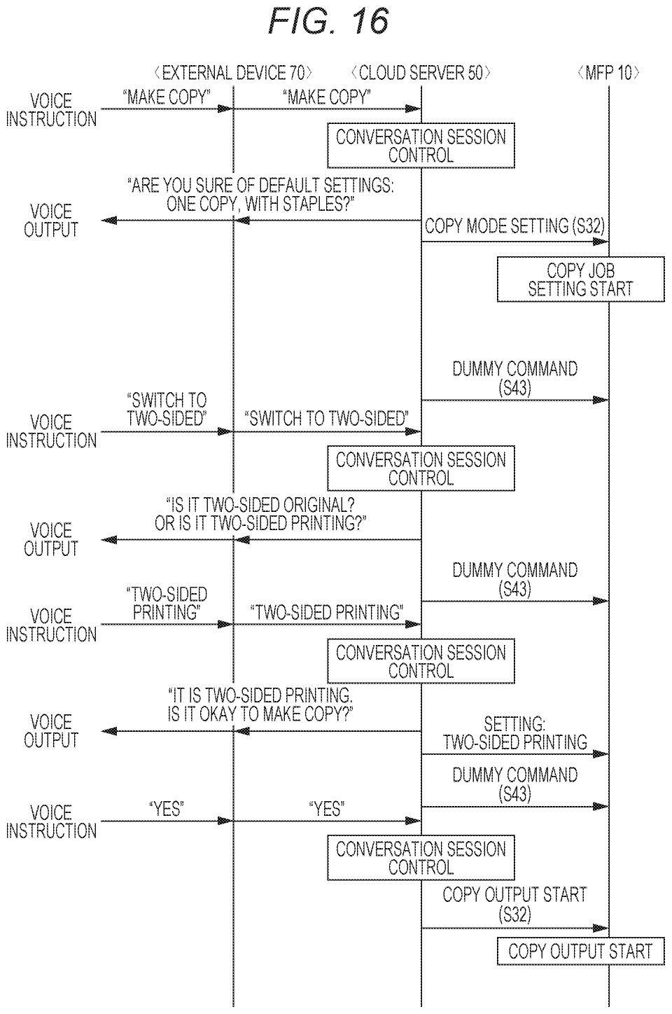

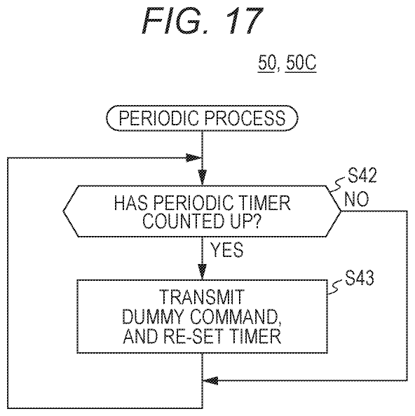

FIG. 15 is a flowchart showing operation of the cloud server 50 (50C) according to the third embodiment. FIG. 16 is a diagram showing an example operation of the image processing system 1 (1C) according to the third embodiment. FIG. 17 is a diagram showing the operation of the cloud server 50 relating to a different routine from that shown in FIG. 15. The MFP 10 (10C) according to the third embodiment performs the same operation as that of the first embodiment (see FIG. 7). In a case where the MFP 10C receives a dummy command from the cloud server 50, the MFP 10C performs the process in step S75 (a timer re-setting process) as in a case where a regular instruction command from the cloud server 50 is received. In this case. the MFP 10C does not need to perform the process in step S74 (FIG. 7).

As shown in FIGS. 15 and 16, the third embodiment differs from the first embodiment in that an explicit auto reset prevention instruction (step S34 (FIG. 5)) and an explicit auto reset prevention cancellation instruction (step S35 (FIG. 5)) are not transmitted.

Further, in the third embodiment, if it is determined in step S33 that it is immediately after the start of a conversation, as shown in FIG. 15, time measurement by a periodic timer 59p (not shown) in the cloud server 50 is started immediately after the start of the conversation (step S41 (FIG. 15)). The periodic timer 59p may be formed with the controller or the like of the cloud server 50, for example.

If it is determined in step S33 that a conversation is being continued, the process returns to step S10. During the period from the start time of a conversation to the end time of the conversation (in other words, while a conversation is being continued), the operation shown in FIG. 17 is also performed by the cloud server 50. The operation shown in FIG. 17 is performed in parallel with the operation shown in FIG. 15.

Specifically, whether the predetermined period (predetermined cycle) L13 has elapsed is determined with the periodic timer 59p in step S42. The predetermined period L13 has a smaller value than the predetermined non-instruction period M1. For example, in a case where the predetermined non-instruction period M1 is “30 seconds”, the predetermined period L13 should be set beforehand at “25 seconds”.

If it is determined in step S42 that the predetermined period L13 has not elapsed yet, the cloud server 50 does not perform the process in step S43 but returns to step S42. If it is determined in step S42 that the predetermined period L13 has elapsed, on the other hand, the cloud server 50 transmits a dummy command to the MFP 10, and re-sets the periodic timer 59p (step S43).

Through such an operation, a dummy command is transmitted from the cloud server 50 to the MFP 10 in the predetermined period L13, while a conversation is being continued. In FIG. 16, a dummy command is transmitted from the cloud server 50 to the MFP 10 every time the predetermined period L13 has elapsed. More specifically, even during the period between the transmission time of “copy setting” (a copy mode setting command) and the transmission time of “setting: two-sided printing” (a two-sided printing setting command), the cloud server 50 transmits a dummy command to the MFP 10 every time the predetermined period L13 has elapsed.

If it is determined in step S33 (FIG. 15) that a conversation has ended, the cloud server 50 ends the use of the periodic timer 59p (step S44), and ends the process shown in FIG. 15 (and FIG. 17).

In a case where a dummy command is received from the cloud server 50, on the other hand, the MFP 10 considers that an instruction from the user (and an instruction command corresponding to the instruction) has been accepted, and prevents execution of an auto reset. More specifically, the MFP 10 re-sets the timer 11p for auto resets in the MFP 10 (or resets the measured time relating to the predetermined non-instruction period M1) (see step S75 (see FIG. 7)), to prevent execution of an auto reset.

In the operation described above, the cloud server 50 transmits a dummy command to the MFP 10 at predetermined time intervals, while a conversation between the user and the audio device 70 is being continued. When the MFP 10 receives a dummy command, the MFP 10 considers that an instruction from the user has been accepted, and prevents execution of an auto reset. Thus, it is possible to prevent the occurrence of unnecessary auto resets in the MFP 10.

Further, receiving a dummy command, the MFP 10 can avoid not only execution of an auto reset, but also execution of an auto logout and execution of an auto sleep. That is, it is also possible to prevent the occurrence of an unnecessary auto logout and the occurrence of an unnecessary auto sleep in the MFP 10,

Here, a “dummy command” may be a new command (such as a “dummy instruction”) that is completely different from a regular instruction command as described above, but is not limited to this.

For example, a dummy command may be the same command as the command transmitted last time. Specifically, after transmitting a copy mode selling command (as a regular command) to the MFP 10, the cloud server 50 may transmit the same command (a copy mode setting command) as a dummy command to the MFP 10. Even if the MFP 10 receives the same command as the command received last time, the command received this time does not substantially affect the operation of the MFP 10. Specifically, even if the MFP 10 receives an instruction (“copy setting” (a copy mode setting command)) to switch to the same mode as the current mode (a copy mode), the mode of the MFP 10 is (substantially) the same, and is not switched. In this manner, the same command as the command transmitted last time may be transmitted as a dummy command.

Alternatively, a setting instruction command relating to a setting item that cannot be set in the current mode (a setting item that is not valid in the current mode) may be transmitted as a dummy command. For example, a command that designates, in a copy mode, the contents (such as “600 dpi”) of a scan setting item “read resolution” that is valid only in a scan mode, a command that designates the contents (such as “PDF format”) of a scan setting item “saved file format” that is valid only in the scan mode, or the like may be transmitted as a dummy command.

Further, a setting instruction command relating to a function that is not provided in the MFP 10 may be transmitted as a dummy command. For example, an instruction command indicating that the set value (the contents) of a setting item “print output size” should be set to “A3” may be transmitted as a dummy command to the MFP 10 that does not have an A3 size print output function. Alternatively, an instruction command indicating that the set value of a setting item “staples” should be set to “present” may be transmitted as a dummy command to the MFP 10 that does not have a stapling function.

Note that a “dummy command” is also called an invalid command (a command that is invalid), a non-significant command or a meaningless command (a command that has no substantial significance (meaning) even if received by the MFP 10), or the like.

### 4. Fourth Embodiment

A fourth embodiment is a modification of the third embodiment. The description below will focus on the differences from the third embodiment.

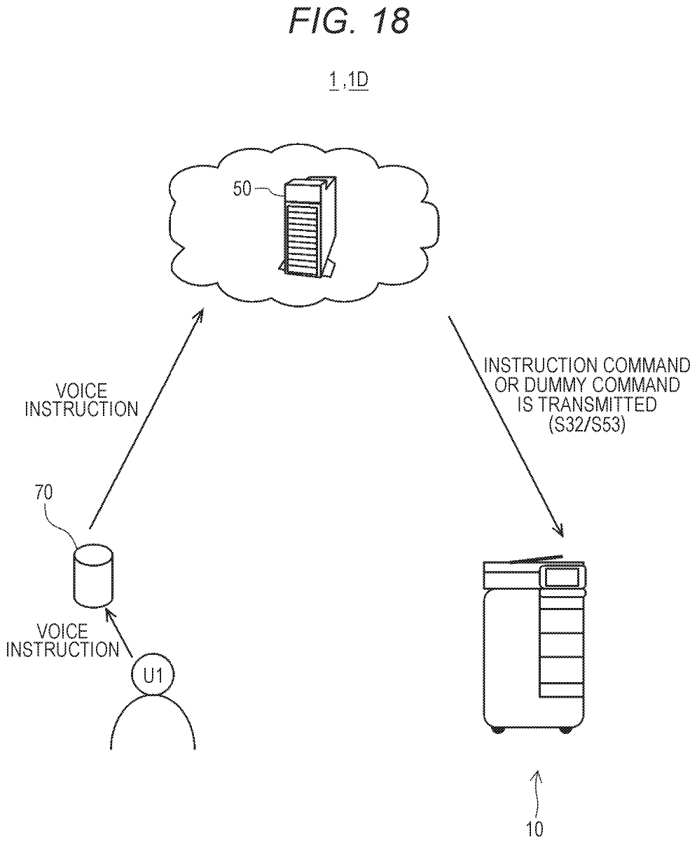

In the third embodiment, a dummy command is periodically transmitted. In other words, a dummy command is transmitted, regardless of the timing of a voice instruction from the user. However, the present invention is not limited to this. For example, a dummy command may be transmitted in synchronization with the timing of a voice instruction (see FIG. 18 and the others). In the fourth embodiment, such an aspect will be described.

FIG. 18 is a conceptual diagram showing operation of an image processing system 1 (1D) according to the fourth embodiment. As shown in FIG. 18, in the fourth embodiment, in synchronization with the timing of a voice instruction issued while a conversation is being continued, either a dummy command or an instruction command (a corresponding command) corresponding to the voice instruction is transmitted.

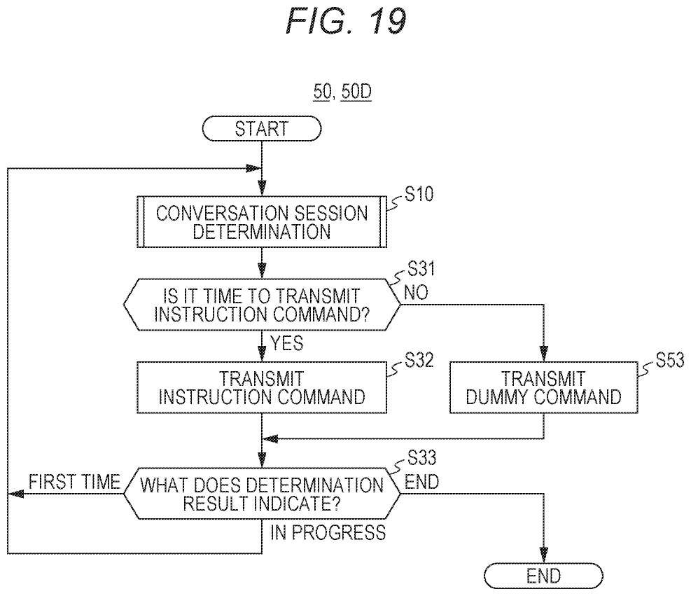

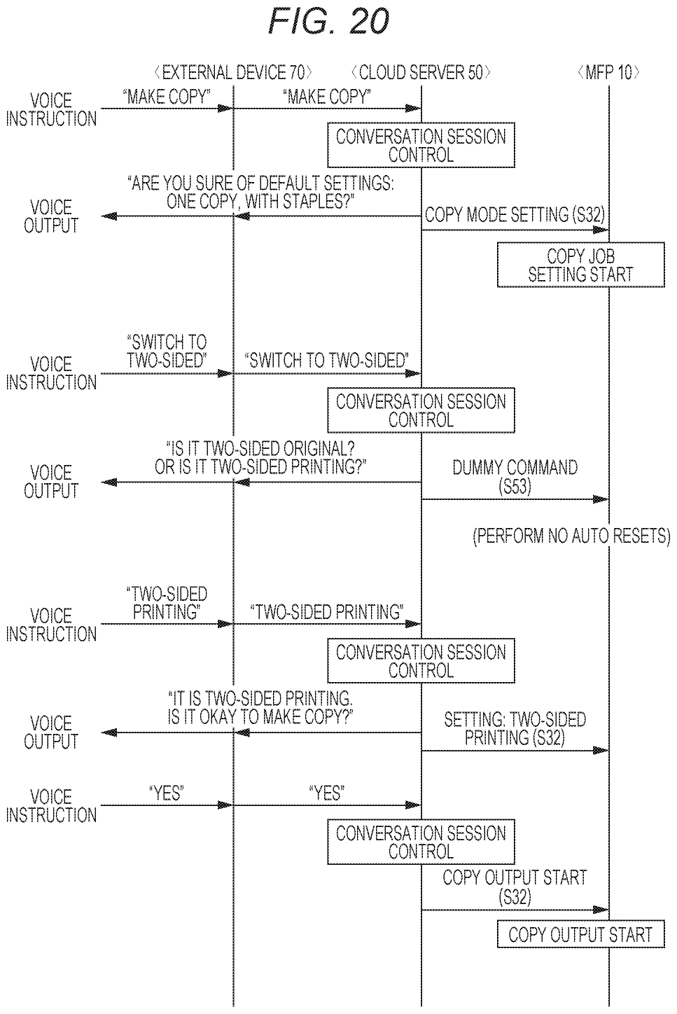

FIG. 19 is a flowchart showing operation of the cloud server 50 (50D) according to the fourth embodiment. FIG. 20 is a diagram showing an example operation of the image processing system 1 (1D) according to the fourth embodiment. The MFP 10 according to the fourth embodiment performs the same operation as that of the third embodiment (see FIG. 7).

As shown in FIG. 19, after a process in accordance with a conversation session determination routine (step S10), the operation moves on to a branching process in step S31.

In step S31, the cloud server 50 determines (decides) whether to transmit an instruction command based on a voice instruction received from the audio device 70 to the MFP 10, in response to the voice instruction. If it is determined that an instruction command based on the voice instruction is to be transmitted to the MFP 10, the cloud server 50 transmits the instruction command to the MFP 10 (step S32). If it is determined that an instruction command based on the voice instruction should not be transmitted to the MFP 10, on the other hand, the process in step S32 is not performed, but a process in step S53 is performed. In step S53, the cloud server 50 transmits a dummy command to the MFP 10.

In step S33, the process branches according to a result of determination regarding the continuity of a conversation. If it is determined that a conversation is being continued (after a voice instruction has been received for the first time, and before the end of the conversation), the process returns to step S10. If the end of the conversation is detected, on the other hand, the process shown in FIG. 19 comes to an end.

For example, as shown in FIG. 20, in a case where a conversation is started upon receipt of a voice instruction “Make a copy.”, it is determined in step S31 that an instruction command based on the voice instruction should be transmitted in response to the voice instruction, and an instruction command (a “copy setting” command) is transmitted from the cloud server 50 to the MFP 10 (step S32 (FIG. 19)) (see also an upper portion of FIG. 20).

Further, in a case where a voice instruction “Switch to two-sided.” is received during the conversation, it is determined that the user should be asked to clarify the contents of the voice instruction (because the contents of the voice instruction are unclear). As a result, it is determined that an instruction command based on the voice instruction should not be transmitted (yet) to the MFP 10 (step S31). A dummy command is then transmitted from the cloud server 50 to the MFP 10 (step S53) (see also a middle portion of FIG. 20).

Further, in a case where a voice instruction “Two-sided printing” is received during the conversation, it is determined that an instruction command based on the voice instruction should be transmitted to the MFP 10, and a regular command (a two-sided printing setting command) is transmitted from the cloud server 50 to the MFP 10 (step S32) (see also a lower portion of FIG. 20).

In the operation as described above, either a regular instruction command or a dummy command is transmitted from the cloud server 50 to the MFP 10, in synchronization with the timing of issuance of a voice instruction. For example, between the time of transmission of “copy setting” (a copy mode setting command) and the time of transmission of “setting: two-sided printing” (a two-sided printing setting command) (more specifically, the timing of issuance of a voice instruction “Switch to two-sided.”), the cloud server 50 also transmits a dummy command to the MFP 10. When the MFP 10 receives a dummy command, the MFP 10 considers that an instruction from the user has been accepted, and prevents execution of an auto reset. Thus, it is possible to prevent the occurrence of unnecessary auto resets in the MFP 10.

### 5. Modifications and Others

Although embodiments of the present invention have been described so far, the present invention is not limited to the above described embodiments.

For example, in each of the above embodiments, the present invention is applied to a setting process relating to a copy job. However, the present invention is not limited to this, and may be applied to a setting process relating to some other job such as a scan job.

Further, in each of the above embodiments, an MFP 10 has been described as an image processing apparatus, but an image processing apparatus is not necessarily an MFP 10. An image processing apparatus may be a copying machine, a print output apparatus (such as a single-function printer), or a scanner apparatus, for example.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing system comprising an image processing apparatus and a cloud server, the image processing system being capable of operating the image processing apparatus through a cooperation process among the image processing apparatus, the cloud server, and an external device.
wherein the cloud server includes:
an acquirer that acquires from the external device a voice instruction for operating the image processing apparatus, the voice instruction being given by the user in a conversation between the user and the external device; and
an instruction transmitter that transmits an instruction command based on the voice instruction to the image processing apparatus,
the image processing apparatus includes:
an operation inputter that accepts an operation input instruction generated by the, user's finger;
a setter that sets settings information relating to an operation of the image processing apparatus, in accordance with at least one of a reception instruction including the instruction command transmitted from the cloud server and the operation input instruction generated by the user's finger; and
a reset controller that performs an auto reset to reset the settings information set by the setter, in response to elapse of a predetermined non-instruction period, and,
when the image processing apparatus starts to be operated by the voice instruction, the reset controller of the image processing apparatus prevents execution of the auto reset.

2. The image processing system according to claim 1,
wherein the image processing apparatus prevents execution of the auto reset by not performing the auto reset even after the predetermined non-instruction period has elapsed.

3. The image processing system according to claim 1,
wherein the image processing apparatus prevents execution of the auto reset by changing a length of the predetermined non-instruction period from a default value to a value greater than the default value, and delaying a timing to start the auto reset.

4. The image processing system according to claim 1,
wherein the image processing apparatus prevents execution of the auto reset while the conversation is being continued between the user and the extend device.

5. The image processing system according to claim 1,
wherein the cloud server further includes:
a detector that detects a start of the conversation between the user and the external device; and
a notifier that notifies the image processing apparatus of an auto reset prevention instruction when the start of the conversation is detected, the auto reset prevention instruction being an instruction indicating that execution of the auto reset is to be prevented, and,
in accordance with the auto reset prevention instruction, the image processing apparatus prevents execution of the auto reset.

6. The image processing system according to claim 5,
wherein the detector further detects an end of the conversation,
when an end of the conversation between the user and the external device is detected, the notifier notifies the image processing apparatus of an auto reset prevention cancellation instruction for canceling the auto reset prevention instruction, and,
in accordance with the auto reset prevention cancellation instruction, the image processing apparatus cancels prevention of execution of the auto reset.

7. The image processing system according to claim 5,
wherein the predetermined non-instruction period is a first non-instruction period,
the image processing apparatus further includes
a sleep controller that performs an auto sleep for causing the image processing apparatus to enter a sleep state in response to elapse of a second non-instruction period, the second non-instruction period having the same length as or a different length from the first non-instruction period, and,
when notified of the auto reset prevention instruction, the image processing apparatus prevents not only execution of the auto reset but also execution of the auto sleep.

8. The image processing system according to claim 5,
wherein the predetermined non-instruction period is a first non-instruction period,
the image processing apparatus further includes
a sleep controller that performs an auto sleep for causing the image processing apparatus to enter a sleep state in response to elapse of a second non-instruction period, the second non-instruction period having the same length as or a different length from the first non-instruction period,
when the start of the conversation is detected, the notifier of the cloud server further notifies the image processing apparatus of an auto sleep prevention instruction, the auto sleep prevention instruction being an instruction indicating that execution of the auto sleep is to be prevented, and,
in accordance with the auto sleep prevention instruction, the image processing apparatus prevents execution of the auto sleep.

9. The image processing system according to claim 5,
wherein the predetermined non-instruction period is a first non-instruction period,
the image processing apparatus further includes
an authentication controller that performs an auto logout for causing the image processing apparatus to switch from a login state to a logout state of the user in response to elapse of a second non-instruction period, the second non-instruction period having the same length as or a different length from the first non-instruction period, and,
when notified of the auto reset prevention instruction, the image processing apparatus prevents not only execution of the auto reset but also execution of the auto logout.

10. The image processing system according to claim 5,
wherein the predetermined non-instruction period is a first non-instruction period,
the image processing apparatus further includes:
an authentication controller that performs an auto logout for causing the image processing apparatus to switch from a login state to a logout state of the user in response to elapse of a second non-instruction period, the second non-instruction period having the same length as or a different length from the first non-instruction period,
when the start of the conversation is detected, the notifier of the cloud server further notifies the image processing apparatus of an auto logout prevention instruction, the auto logout prevention instruction being an instruction indicating that execution of the auto logout is to be prevented, and,
in accordance with the auto logout prevention instruction, the image processing apparatus prevents execution of the auto logout.

11. The image processing system according to claim 1,
wherein the cloud server further includes
a determiner that determines whether the conversation between the user and the external device is being continued,
the image processing apparatus further includes
an inquirer that inquires of the cloud server whether the conversation is being continued, and,
when a reply indicating that the conversation is being continued is received from the cloud server, the image processing apparatus prevents execution of the auto reset.

12. The image processing system according to claim 11,
wherein the predetermined non-instruction period is a first non-instruction period,
the image processing apparatus further includes
a sleep controller that performs an auto sleep for causing the image processing apparatus to enter a sleep state in response to elapse of a second non-instruction period, the second non-instruction period having the same length as or a different length from the first non-instruction period, and,
when a reply indicating that the conversation is being continued is received from the cloud server, the image processing apparatus prevents not only execution of the auto reset but also execution of the auto sleep.

13. The image processing system according to claim 11,
wherein the predetermined non-instruction period is a first non-instruction period,
the image processing apparatus further includes
an authentication controller that performs an auto logout for causing the image processing apparatus to switch from a login state to a logout state of the user in response to elapse of a second non-instruction period, the second non-instruction period having the same length as or a different length from the first non-instruction period, and,
when a reply indicating that the conversation is being continued is received from the cloud server, the image processing apparatus prevents not only execution of the auto reset but also execution of the auto logout.

14. The image processing system according to claim 1,
wherein the cloud server further includes
a determiner that determines whether the conversation between the user and the external device is being continued,
the instruction transmitter transmits a dummy command to the image processing apparatus while the conversation is being continued, and,
when the dummy command is received, the image processing apparatus considers that an instruction from the user has been accepted, and resets a measured time relating to the predetermined non-instruction period.

15. The image processing system according to claim 14,
wherein the instruction transmitter transmits the dummy command to the image processing apparatus at predetermined intervals while the conversation is being continued.

16. The image processing system according to claim 14.
wherein the cloud server further includes
a decider that decides whether to transmit the instruction command based on the voice instruction to the image processing apparatus in response to the voice instruction,
when it is decided that the instruction command based on the voice instruction is to be transmitted to the image processing apparatus in response to the voice instruction, the instruction transmitter transmits the instruction command based on the voice instruction to the image processing apparatus in response to the voice instruction, and,
when it is decided that the instruction command based on the voice instruction is not to be transmitted to the image processing apparatus in response to the voice instruction, the instruction transmitter transmits the dummy command to the image processing apparatus in response to the voice instruction.

17. The image processing system according to claim 1,
wherein the predetermined non-instruction period is a period during which both an instruction via the external device and the cloud server and an instruction via an operation inputter of the image processing apparatus do not exist.

18. An image processing apparatus capable of cooperating with a cloud server and an external device, the image processing apparatus comprising:
a receiver that receives from the cloud server an instruction command for operating the image processing apparatus, the instruction command being based on a voice instruction given by a user in a conversation between the user and the external device;
an operation inputter that accepts an operation input instruction generated by the user's finger;
a setter that sets settings information relating to an operation of the image processing apparatus, in accordance with at least one of a reception instruction including the instruction command transmitted from the cloud server and the operation input instruction generated by the user's finger; and
a reset controller that performs an auto reset for resetting the settings information set by the setter, in response to elapse of a predetermined non-instruction period,
wherein, when the image processing apparatus starts to be operated by the instruction command based on the voice instruction, the reset controller prevents execution of the auto reset.

19. A non-transitory recording medium storing a computer readable program installed in a computer in an image processing apparatus capable of cooperating with a cloud server and an external device, the program causing the computer to perform:
a) receiving from the cloud server an instruction command for operating the image processing apparatus, the instruction command being based on a voice instruction given by a user in a conversation between the user and the external device;
b) setting settings information relating to an operation of the image processing apparatus, in accordance with at least one of a reception instruction including the instruction command transmitted from the cloud server and an operation input instruction generated by the user's finger and transmitted via an operation inputter of the image processing apparatus; and
c) when the image processing apparatus starts to be operated by the instruction command based on the voice instruction, preventing execution of an auto reset for resetting the settings information b) in response to elapse of a predetermined non-instruction period.

20. A cloud server capable of cooperating with an image processing apparatus and an external device, the cloud server comprising:
an acquirer that acquires from the external device a voice instruction for operating the image processing apparatus, the voice instruction being given by a user in a conversation between the user and the external device;
an instruction transmitter that transmits an instruction command based on the voice instruction to the image processing apparatus;
a determiner that determines whether the conversation between the user and the external device is being continued; and
a notifier that transmits a notification for preventing execution of an auto reset to the image processing apparatus when it is determined that the conversation is being continued, the auto reset being for resetting settings information set in the image processing apparatus in response to elapse of a predetermined non-instruction period.

21. The cloud server according to claim 20,
wherein, when it is determined that the conversation is being continued, the notifier transmits an auto reset prevention instruction to the image processing apparatus, to cause the image processing apparatus to prevent execution of the auto reset, the auto reset prevention instruction being an instruction indicating that execution of the auto reset is to be prevented.

22. The cloud server according to claim 20,
wherein, when it is determined that the conversation is being continued, the notifier transmits a dummy command to the image processing apparatus, to cause the image processing apparatus to prevent execution of the auto reset.

23. A non-transitory recording medium storing a computer readable program installed in a computer in a cloud server capable of cooperating with an image processing apparatus and an external device, the program causing the computer to perform:
a) acquiring from the external device a voice instruction for operating the image processing apparatus, the voice instruction being given by a user in a conversation between the user and the external device;
b) transmitting an instruction command based on the voice instruction to the image processing apparatus;
c) determining whether the conversation between the user and the external device is being continued; and
d) when it is determined that the conversation is being continued, transmitting a notification for preventing execution of an auto reset to the image processing apparatus, the auto reset being for resetting settings information set in the image processing apparatus in response to elapse of a predetermined non-instruction period.

24. The non-transitory recording medium storing a computer readable program according to claim 23,
wherein the d) includes
d-1) when it is determined that the conversation is being continued, transmitting an auto reset prevention instruction to the image processing apparatus, to cause the image processing apparatus to prevent execution of the auto reset, the auto reset prevention instruction being an instruction indicating that execution of the auto reset is to be prevented.

25. The non-transitory recording medium storing a computer readable program according to claim 23.
wherein the d) includes
d-2) when it is determined that the conversation is being continued, transmitting a dummy command to the image processing apparatus, to cause the image processing apparatus to prevent execution of the auto reset.

26. The non-transitory recording medium storing a computer readable program according to claim 25,
wherein the d-2) includes
d-2-1) when it is determined that the conversation is being continued, transmitting the dummy command to the image processing apparatus at predetermined time intervals, to cause the image processing apparatus to prevent execution of the auto reset.

27. The on-transitory recording medium storing a computer readable program according to claim 25,
wherein the program further causes the computer to perform
e) deciding whether to transmit the instruction command based on the voice instruction to the image processing apparatus in response to the voice instruction;
when it is decided in the e) that the instruction command based on the voice instruction is to be transmitted to the image processing apparatus in response to the voice instruction, the instruction command based on the voice instruction is transmitted to the image processing apparatus in response to the voice instruction in the b), and
when it is decided in the e) that the instruction command based on the voice instruction is not to be transmitted to the image processing apparatus in response to the voice instruction, the dummy command is transmitted to the image processing apparatus in response to the voice instruction in the d-2), to prevent execution of the auto reset.
